(19) United States
(12) Patent Application Publication
(10) Pub. No.: US 2014/0122116 A1
(43) Pub. Date: May 1, 2014

(54) System and method for providing audio data to assist in electronic medical records management

(71) Applicant: Alan H. Smythe, White Bear Lake, MN (US)

(72) Inventor: Alan H. Smythe, White Bear Lake, MN (US)

(21) Appl. No.: 11/176,796

(22) Filed: Jul. 6, 2005

(51) Int. Cl. G06F 19/00; G06Q 50/22; G06Q 10/10

(52) U.S. Cl. CPC G06F 19/322; G06Q 10/1095; G06Q 50/22
USPC 705/3

(57) ABSTRACT

A system and method for providing audio data to assist in electronic medical records management is presented. A plurality of patient electronic health records are maintained. Each patient electronic health record stores non-audio patient medical information identifiable by patient. Storage and retrieval of the patient electronic health records is managed through an electronic medical records system. Audio data recorded by a healthcare provider to chronicle at least one aspect of health for a patient is stored. The audio data is associated with the patient electronic health record in the electronic medical records system corresponding to the patient. The audio data for the patient is securely accessed through a non-content-based index keyed to the electronic medical records system.

### FIELD OF THE INVENTION

The present invention relates in general to electronic medical records management and, specifically, to a system and method for providing audio data to assist in electronic medical records management.

### BACKGROUND OF THE INVENTION

A patient's medical history is a key source of information used in modern clinical practice to collect information obtained directly from the patient and data gathered from other sources. Each medical history documents the patient's physical status and physiological, social, and sexual functions and provides a basis for diagnosis, treatment, care, and follow-up. Generally, the medical history includes written and transcribed notes supplemented by printed laboratory and testing documentation. The medical history is reviewed typically by a healthcare provider prior to a patient interview and to provide a referral or consultation to a requesting colleague.

Often, a healthcare provider will dictate verbal notes and observations, either during or following a patient interview. The dictation, in the form of audio data, is later transcribed into written form for proofing by the healthcare provider prior to being added to the medical history of the patient. Dictation is fast and conventional and enables healthcare providers to efficiently capture patient-related data while keeping pace with a busy clinical practice, particularly in managed healthcare environments where patient interview times are limited.

Recently enacted medical information privacy laws, including the Health Insurance Portability and Accountability Act (HIPAA) and the European Privacy Directive (EPD) underscore the importance of safeguarding a patient's privacy safety and require the protection of all patient-identifiable health information (PHI), such as recorded in medical histories. Under HIPAA, PHI is defined as individually identifiable health information, including identifiable demographic and other information relating to the past, present or future physical or mental health or condition of an individual, or the provision or payment of health care to an individual that is created or received by a health care provider, health plan, employer or health care clearinghouse. Other types of sensitive information in addition to or in lieu of PHI could also be protectable.

Increasingly, patient medical histories are being maintained in digital form on electronic medical record (EMR) systems, which maintain a set of patient medical records collectively storing an electronic health record (EHR) containing patient information, including medical histories, as well as appointment, billing, insurance, and other patient data. Due to patient privacy concerns, such as HIPAA and EPD mandates, EMR systems are generally intended for in-clinic or in-hospital use and are not openly connected to publicly-available networks, such as the Internet.

Audio data, in particular, dictation, has historically been treated as being separate from EHRs. Dictation is generally viewed as being in a “raw” and unfinished form until transcribed into text. Once proofed by the healthcare provider, the “raw” dictation is discarded as no longer being of use, particularly where the dictation was generated using analog audiotapes, which are not readily amendable to electronic storage and retrieval. Current forms of dictation, however, are increasingly being generated as digital data, yet are nevertheless discarded as data superseded by text.

Despite the best efforts put forth by transcribers, medical transcriptions of dictation are not infallible. Transcription is based on what the transcribers have interpreted from the actual dictation and information can still be missed or omitted inadvertently. Inaccuracies can still occur due to typographical errors, bad media, misunderstood words, and language barriers, to name but a few factors. Proofing can increase the accuracy of transcription, but the passage of time, distance, and various pressures on healthcare providers erode the assurance that proofing will correct all transcription errors.

Therefore, there is a need for an approach to integrating audio data, such as dictation in digital form, into traditional EMR systems that includes a means for accessing and retrieving such audio data through a plurality of modalities. Preferably, such an approach would accommodate a plurality of audio data forms, plus other types of non-audio data. Preferably, such an approach would further include temporal review and scheduling features for EHRs, consultations, and referrals. Finally, such an approach would preferably allow for an integration of transcription and translation functionality.

### SUMMARY OF THE INVENTION

The invention provides a system and method for storing and retrieving audio data from patient electronic health records (EHRs), including medical histories, maintained by an electronic medical record (EMR) system. Audio data, in the form of digitally recorded voice or sound, is identified with a particular patient and a corresponding EHR is securely retrieved from the EMR system. An index entry is created for the audio data, which forms an association between the retrieved EHR and the audio data. Subsequently, the audio data can be accessed through the index keyed to the EMR system.

One embodiment provides a system and method for providing audio data to assist in electronic medical records management. A plurality of patient electronic health records are maintained. Each patient electronic health record stores non-audio patient medical information identifiable by patient. Storage and retrieval of the patient electronic health records is managed through an electronic medical records system. Audio data recorded by a healthcare provider to chronicle at least one aspect of health for a patient is stored. The audio data is associated with the patient electronic health record in the electronic medical records system corresponding to the patient. The audio data for the patient is securely accessed through a non-content-based index keyed to the electronic medical records system.

Still other embodiments of the present invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a process flow diagram showing prior art integration of transcribed audio data into patient electronic health records.

FIG. 2 is a block diagram showing a system for providing audio data to assist in electronic medical records management, in accordance with one embodiment.

FIG. 3 is a block diagram showing an electronic medical records system, such as used in the system of FIG. 1.

FIG. 4 is a diagram showing, by way of example, a data structure for an audio data record.

FIG. 5 is a flow diagram showing a method for providing audio data to assist in electronic medical records management, in accordance with one embodiment.

FIG. 6 is a flow diagram showing a routine for obtaining a cryptographic key for use in the method of FIG. 5.

FIG. 7 is a flow diagram showing a routine for annotating audio data for use in the method of FIG. 5.

FIG. 8 is a flow diagram showing a routine for accessing audio data for use in the method of FIG. 5.

### DETAILED DESCRIPTION

### Process Flow

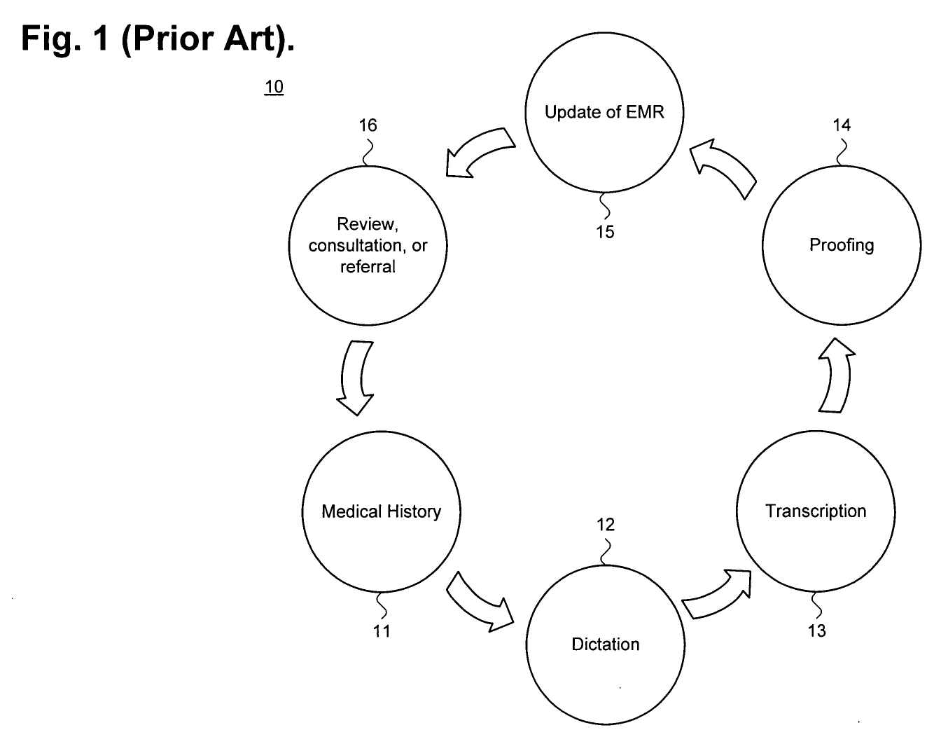

FIG. 1 is a process flow diagram showing prior art integration 10 of transcribed audio data into patient electronic health records (EHRs). Conventionally, audio data is generated either during or after the taking of a patient's medical history (operation 11). The audio data is recorded as dictation (operation 12) that is reduced into a written form through transcription (operation 13). The raw transcription is then reviewed by the healthcare provider through proofing (operation 14) before being authorized as an update of the electronic medical records (EMR) for each patient (operation 15). Later, the transcription is accessed during pre-patient interview review, consultation, or referral (operation 16). The cycle of integrating transcribed audio data into EMRs is on-going and represents an integral part of standard healthcare provision. However, the integration of the actual audio data directly into the EMRs is generally omitted and, following transcription (operation 13) or proofing (operation 14), the raw dictation is typically discarded and permanently lost.

### System Overview

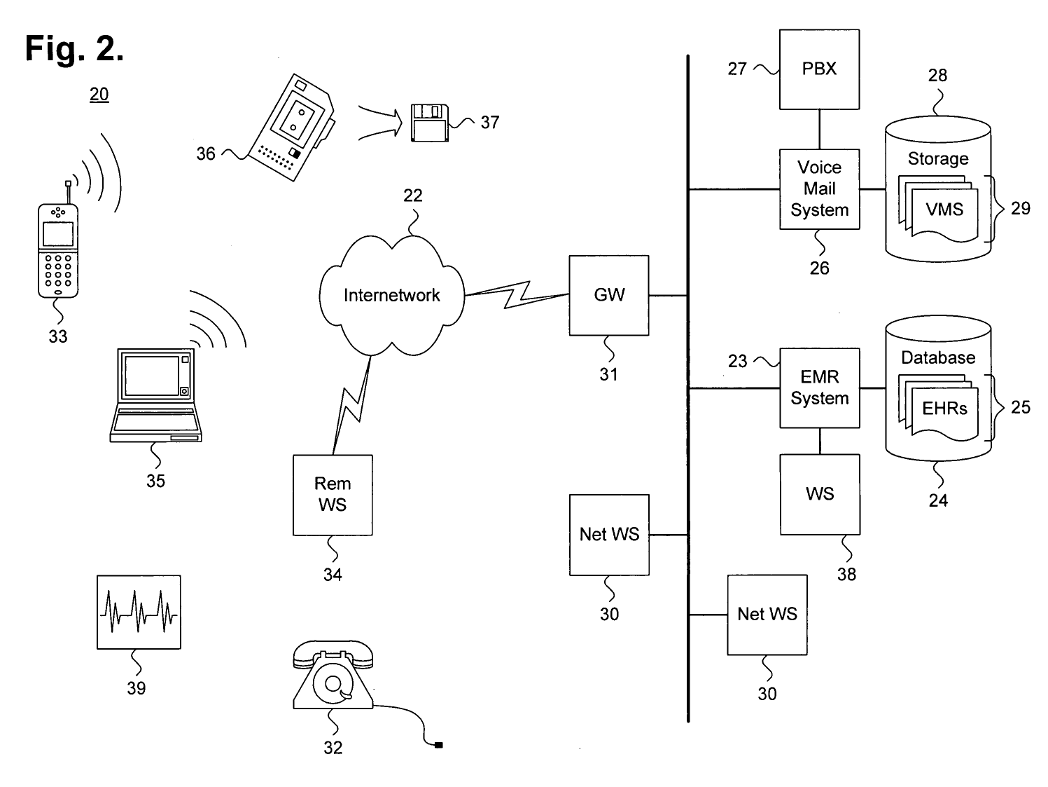

FIG. 2 is a block diagram showing a system 20 for providing audio data to assist in electronic medical records management, in accordance with one embodiment. A set of patient electronic health records (EHRs) 25 is maintained in a database 24 that is coupled to an EMR system 23. Each patient EHR 25 contains patient-identifiable information, such as written medical histories, laboratory and testing results, and related information, such as billing, appointment, and insurance data. Other types patient-identifiable information are possible. The EMR system 23 allows healthcare providers, such as physicians, nurses, and professional staff, to access the patient EHRs 25 through a user interface provided by workstations 38 or networked workstations 30 that are interconnected over a local area network 21 for in-clinic or in-hospital access. In a further embodiment, the patient EHRs 25 can be accessed from outside the clinic or hospital through remote workstations 34 interconnected, by way of example, over an internetwork 22, such as the Internet, which is securely connected to the local area network 21 through a gateway 31 or similar secure means for public network access. In a still further embodiment, the patient EHRs 25 can be accessed from outside the clinic or hospital through a conventional telephone voice exchange that implements secure access measures to prevent unauthorized access. In one embodiment, a suitable EMR system 23 is Centricity Physician Office EMR system, sold and licensed GE Healthcare, Chalfont St. Giles, U.K.

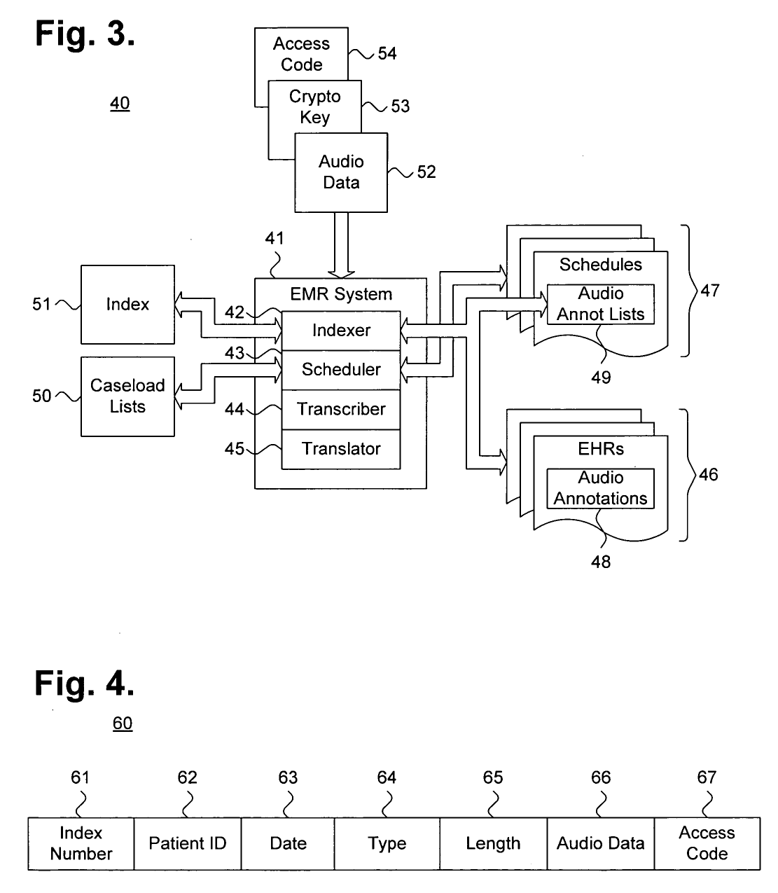

In addition to the EMR system 23, a voicemail system 26 provides telephone messaging services and is coupled to a public telephone exchange (PBX) 27 as part of the telephone system for the clinic or hospital environment. Individual voicemails (VMs) 29 are maintained in a storage device 28 coupled to the voicemail system 26. Users can access the voicemail system 26 through conventional Plain Old Telephone System (POTS) handsets 32 and cellular telephones 33. Other forms of voicemail access are possible. Healthcare providers directly generate dictation 37 using dedicated recording devices, such as personal voice recorders 36, or indirectly through portable computers 35 or workstations 30, 34, 38, which are connected directly or wirelessly to the local area network 21. Personal voice recorders 36 can be portable or stationary. As well, acoustical data streams 39 can be generated by audio stethoscopes to record heart sounds and similar devices in a digital data format. Other types of digital and analogue recording devices are possible. Audio data is integrated into the patient EHRs 25 by the EMR system 23, as further described below beginning with reference to FIG. 3, for access by healthcare provides through user interfaces provided by the workstations 38 or networked workstations. Audio data can include voice messages 29, dictation 37, and acoustical data streams 39, as well as digital data and analogue data converted into digital format that have originated from or been generated by other sources, both portable and stationary, interconnected to the EMR system 23 through digital interfacing means.

### Electronic Medical Records System

FIG. 3 is a block diagram showing an electronic medical records (EMR) system 41, such as used in the system 20 of FIG. 1. The EMR system 41 includes an indexer 42, scheduler 43, and, optionally, a transcriber 44 and translator 45. The indexer 42 generates an index 51 that associates audio data 52 with specific patient electronic health records (EHRs) 46 in the form of audio annotations 48. In one embodiment, the audio data 52 can originate from voicemail 29, dictation 37, or acoustical data streams 39, although other sources of audio data are possible. In addition, the audio data 52 is stored in digital form, such as in a .wav or .mpeg file format, although other file formats are possible. In one embodiment, the index 51 is non-content-based and keys each audio annotation 48 to a specific patient EHR 46, as further described below with reference to FIG. 4, although other associations of audio annotations 48 and patient EHRs 46 are possible.

The scheduler 43 creates a set of caseload lists 50 that identify those patients scheduled to be seen by a particular health care provider on a particular day or over a specific timeframe. The scheduler 43 also generates schedules 47 that group the audio annotations 48 into audio annotation lists 49 generated by the indexer 42 by corresponding day or timeframe for a healthcare provider. The audio annotation lists 49 includes a set of links that logically connect the audio annotations 48. Through the audio annotation lists 49, a healthcare provider can navigate through the audio data 52 for those patients scheduled in their caseload list 50, including being able to pre-review audio data 52 prior to seeing patients. In addition, scheduler 43 can forward audio annotations 48, as well as associated patient EHRs 46, to a consulting or referred healthcare provider.

In a further embodiment, the schedules 47 includes audio annotations 48 in the audio annotation lists 49 that extend with or beyond the scheduled day or timeframe to form a longitudinal history for the patient. Through the longitudinal history, a healthcare provider can review prior audio annotations over the extended timeframe. Other types of schedules 47 and orderings of audio annotations are possible. In a still further embodiment, the indexer 42 associates an access code 54 with the audio annotations 48 to facilitate access control over the audio data record 60. Access control includes the ability to listen to, modify, or delete an audio annotation 48. The same or different access code 54 for each healthcare provider can be used for the audio annotations 48 for the same patient.

The optional transcriber module 44 and translator module 45 respectively convert speech to text and written text into text in another language. Results of both transcriber module 44 and translator module 45 are added into the patient EHRs 46. Other types of modules providing additional functionality are possible. Finally, the EMR system 41 retrieves a cryptographic key 53 that is used to encrypt and decrypt any sensitive information, such as patient EHRs 46, exchanged outside the EMR system 41.

### Audio Data Record Data Structure

FIG. 4 is a diagram showing, by way of example, a data structure for an audio data record 60. By way of example, each audio data record 60 includes an index number 61, patient identifier 62, date 63, type 64, and length 65, plus the audio data 66 in digital form with, in a further embodiment, an associated access code 67. The index number 61 uniquely identifies the audio data record 60 while the patient identifier 62 associates each particular audio data record 60 with a patient EHRs 46 (shown in FIG. 3). The date 63 identifies the time and date at which the audio data was created and the type 64 and length 65 respectively indicate the kind of audio data 66 stored, that is, voice or video, and playing time. Finally, the access code 67 control access to the audio data record 60. Other fields and data can be stored in the audio data record 60.

### Method Overview

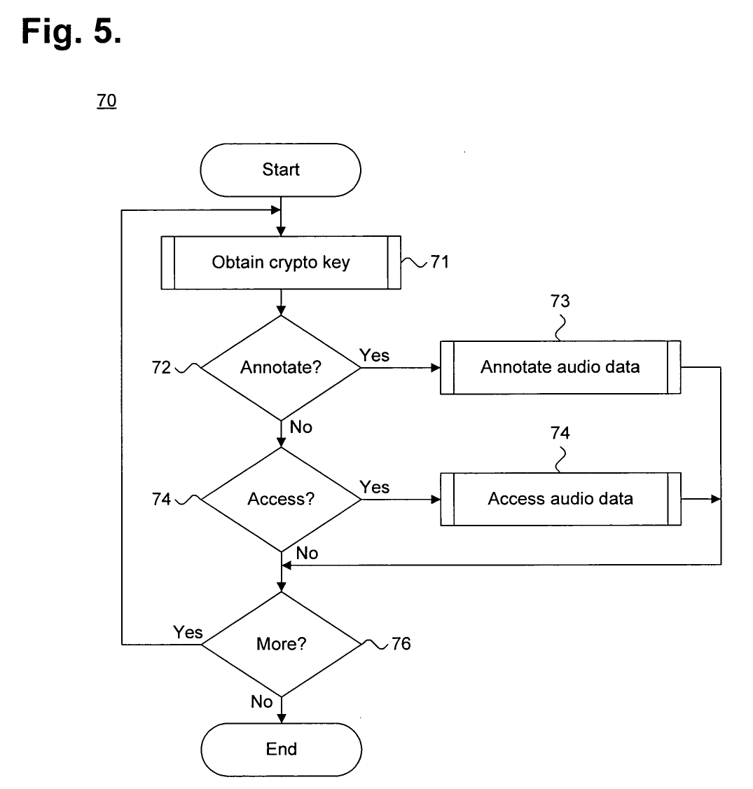

FIG. 5 is a flow diagram showing a method 70 for providing audio data to assist in electronic medical records management, in accordance with one embodiment. The purpose of this method is to associate audio data 52 (shown in FIG. 3) with patient EHRs 46. The method 70 is described as a sequence of process operations or steps, which can be executed, for instance, by an EMR system 41.

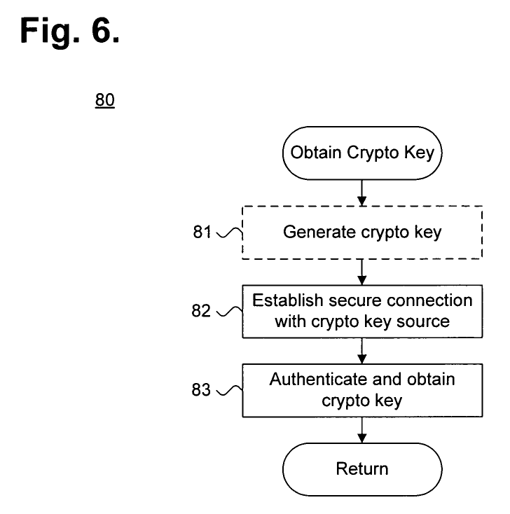

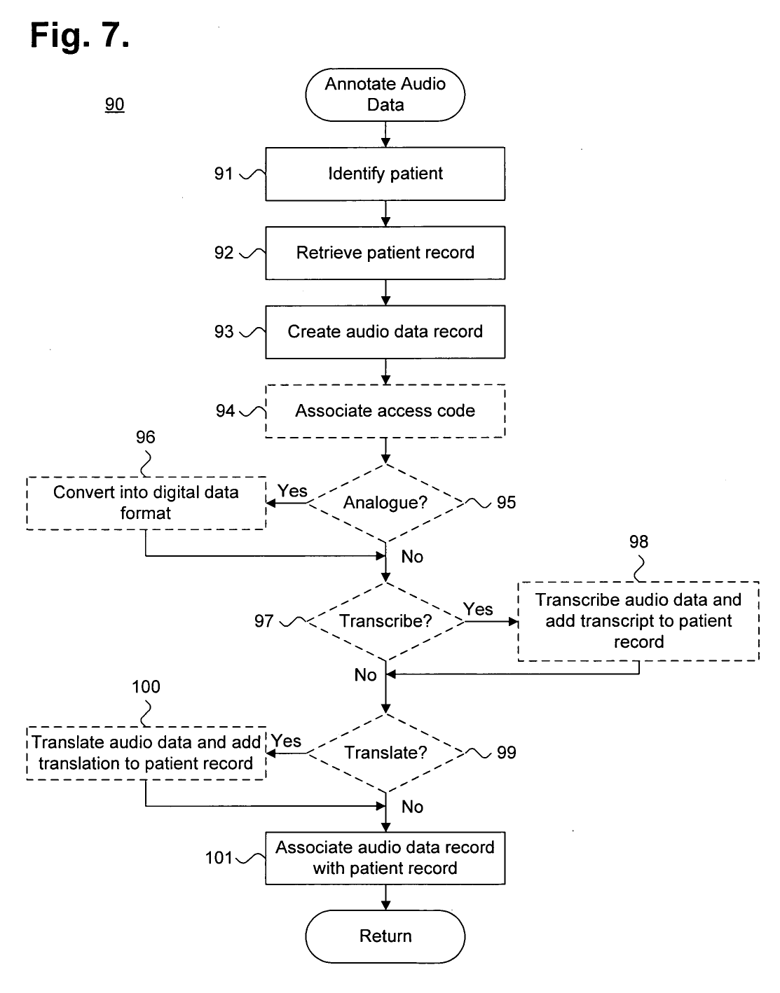

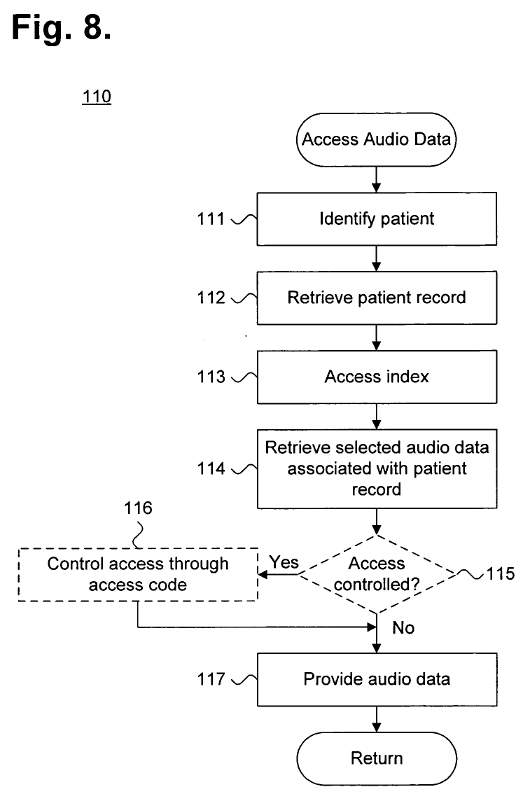

The method begins by obtaining a cryptographic key (block 71), as further described below with reference to FIG. 6. The cryptographic key 53 is used to encrypt and decrypt any sensitive information exchanged outside the EMR system 41, such as during storage and retrieval of audio annotations 48 over a public network, such as the Internet. Upon successful obtaining of the cryptographic key 53, new audio data 52 can be annotated (block 72) into a patient EHR 46 (block 73), as further described below with reference to FIG. 7, or existing audio data (block 74) can be accessed (block 75), as further described below with reference to FIG. 8. If further processing of audio data 52 is required (block 76), a cryptographic key 53 is again obtained (block 71) if required, and processing continues as described above.

### Cryptographic Key Obtainment

FIG. 6 is a flow diagram showing a routine 80 for obtaining a cryptographic key 53 for use in the method 70 of FIG. 5. The purpose of this routine is to securely receive a cryptographic key 53 uniquely assigned to an EMR system 41 to facilitate secure exchange of sensitive information.

Initially, the cryptographic key 53 is optionally generated (block 81). Depending upon the system, the cryptographic key 53 can be generated dynamically as a session key by the EMR system 41 for subsequent download. Similarly, the cryptographic key 53 could be generated during a manufacturing process and persistently stored in the EMR system 41. Alternatively, the cryptographic key 53 could be dynamically generated by the requesting system.

Next, a secure connection is established with the source of the cryptographic key 53 (block 82). The form of the secure connection is dependent upon the type of key source. For instance, if the key source is the EMR system 41, the secure connection could be established by secure link or dedicated hardwired connection. Finally, the cryptographic key 53 is authenticated and obtained (block 83) by storing the cryptographic key 53 into the requesting system.

### Audio Data Annotation

FIG. 7 is a flow diagram showing a routine 90 for annotating audio data for use in the method 70 of FIG. 5. The purpose of this routine is to add new audio data 52 (shown in FIG. 3) into a patient EHR 46.

Initially, the patient to whom the audio data 52 corresponds is identified (block 91) and the matching patient EHR 46 is securely retrieved using the cryptographic key 53 (block 92). A new audio data record 60 (shown in FIG. 4) is created (block 93). In a further embodiment, an access code 54 can be associated with audio data record 60 to facilitate access control (block 94). Similarly, in a further embodiment, if the audio data 52 is in an analogue format (block 95), the audio data 52 can be converted into a digital data format (block 96). As well, in a still further embodiment, if the audio data 66 is to be transcribed (block 97), the audio data 52 is transcribed and the resulting transcript is added to the patient EHR 46 (block 98). Likewise, if the audio data 52, in the form of a transcript, is to be translated into another language (block 99), the audio data 52 is translated and the translation is added to the patient EHR 46 (block 100). Finally, the audio data record 60 is associated with the patient EHR 46 (block 101), for instance, by indicating the appropriate patient identifier 62 in the audio data record 60.

### Audio Data Access

FIG. 8 is a flow diagram showing a routine 110 for accessing audio data for use in the method 70 of FIG. 5. The purpose of this routine is to retrieve existing audio data 66 (shown in FIG. 4) from a patient EHR 46.

Initially, the patient to whom the audio data corresponds is identified (block 111) and the matching patient EHR 46 is securely retrieved using the cryptographic key 53 (block 112). The index 51 (shown in FIG. 3) is accessed (block 113) to determine the associated audio data record, which is then retrieved (block 114). In a further embodiment, if access to the audio data record 60 is controlled (block 115), an access code is obtained from the requester and access is controlled (block 116). Finally, the audio data is provided to the requester (block 117).

While the invention has been particularly shown and described as referenced to the embodiments thereof, those skilled in the art will understand that the foregoing and other changes in form and detail may be made therein without departing from the spirit and scope of the invention.

1. A system for providing audio data records to assist in electronic medical records management, comprising:
a database to maintain a plurality of patient electronic health records, wherein each patient electronic health record stores non-audio patient medical information identifiable by patient;
an electronic medical records system to manage storage and retrieval of the patient electronic health records;
stored audio data records wherein each audio data record comprises an index number, a patient identifier, a data, a type, a length, and audio data recorded by a healthcare provider to chronicle at least one aspect of health for a patient;
a non-content-based index to associate the audio data with specific patient electronic health records of the plurality of patient electronic health records in the electronic medical records system corresponding to the patient in the form of audio annotations;
a scheduler to create a set of caseload lists that identify those patients scheduled to be seen by a particular health care provider on a particular day and generate schedules that group the audio annotations into audio annotation lists; and
an indexer to securely access the audio data for the patient through the index.

2. A system according to claim 1, further comprising:
an access code associated with the audio data to control access.

3. (canceled)

4. A system according to claim 1, further comprising:
a longitudinal history to logically link the audio data; and
a user interface to navigate through the audio data.

5-6. (canceled)

7. A system according to claim 1, wherein the audio data can be pre-reviewed at a time occurring prior to the schedule.

8. (canceled)

9. A system according to claim 1, further comprising:
a transcriber to transcribe the audio data.

10. A system according to claim 1, further comprising:
a translator to translate the audio data.

11. A system according to claim 1, wherein the audio data is portably recorded using at least one of a voice recorder and personal computer.

12. A system according to claim 1, wherein the audio data is accessed via at least one of a dialup connection, email, personal computer application, and secure telephone voice exchange.

13. A system according to claim 1, wherein the audio data comprises at least one of a digital recording, voicemail, and acoustical data stream in one of a digital data format or analogue data format converted into the digital data format.

14. A method for providing audio data to assist in electronic medical records management, comprising:
maintaining a plurality of patient electronic health records, wherein each patient electronic health record stores non-audio patient medical information identifiable by patient;
managing storage and retrieval of the patient electronic health records through an electronic medical records system;
storing audio data records, wherein each audio data record comprises an index number, a patient identifier, a data, a type, a length, and audio data recorded by a healthcare provider to chronicle at least one aspect of health for a patient;
associating the audio data with specific patient electronic health records of the plurality of patient electronic health records in the electronic medical records system corresponding to the patient in the form of an audio annotation;
creating a set of caseload lists that identify patients scheduled to be seen by a particular health care provider on a particular day;
generating schedules that group a plurality of audio annotations into an audio annotation list, wherein the audio annotation list groups the audio annotations by timeframe; and
securely accessing the audio data for the patient through a non-content-based index keyed to the electronic medical records system.

15. A method according to claim 14, further comprising:
associating an access code with the audio data to control access.

16. A method according to claim 14, further comprising:
generating a cryptographic key to encrypt and decrypt the non-audio patient medical information identifiable by patient for exchange outside the electronic medical records system.

17. (canceled)

18. A method according to claim 14, further comprising:
logically linking the audio data; and
navigating through the audio data.

19. A method according to claim 14, further comprising:
forwarding the audio annotations to a second healthcare provider.

20. (canceled)

21. A method according to claim 14, further comprising:
pre-reviewing the audio data at a time occurring prior to the schedule.

22. A method according to claim 14, further comprising at least one of:
transcribing the audio data;
translating the audio data; and
forwarding the accessed audio data to another healthcare provider.

23. A method according to claim 14, wherein the audio data is portably recorded using at least one of a voice recorder and personal computer.

24. A method according to claim 14, wherein the audio data is accessed via at least one of a dialup connection, email, personal computer application, and secure telephone voice exchange.

25. A method according to claim 14, wherein the audio data comprises at least one of a digital recording, voicemail, and acoustical data stream in one of a digital data format or analogue data format converted into the digital data format.

26. A non-transitory computer-readable storage medium to assist in electronic medical records management, comprising:
code for maintaining on a computer-readable storage medium a plurality of patient electronic health records, wherein each patient electronic health record stores non-audio patient medical information identifiable by patient;
code for managing storage and retrieval of the patient electronic health records through an electronic medical records system on a computer-readable storage medium;
code for storing on a computer-readable storage medium an audio data record comprising an index number, a patient identifier, a data, a type, a length, and audio data recorded by a healthcare provider to chronicle at least one aspect of health for a patient;
code for associating the audio data with specific patient electronic health records in the electronic medical records system corresponding to the patient in the form of an audio annotation;
code for creating a set of caseload lists that identify those patients scheduled to be seen by a particular health care provider on a particular day;
code for generating schedules that group a plurality of audio annotations into audio annotation lists, wherein each audio annotation list comprises a set of links that logically connect the audio annotations; and
code for securely accessing the audio data for the patient through a non-content-based index keyed to the electronic medical records system.

27. An apparatus for providing audio data to assist in electronic medical records management, comprising:
means for maintaining a plurality of patient electronic health records, wherein each patient electronic health record stores non-audio patient medical information identifiable by patient;
means for managing storage and retrieval of the patient electronic health records through an electronic medical records system
means for storing an audio data record comprising an index number, a patient identifier, a data, a type, a length, and audio data recorded by a healthcare provider to chronicle at least one aspect of health for a patient;
means for associating the audio data with specific patient electronic health records in the electronic medical records system corresponding to the patient in the form of an audio annotation;
means for creating a set of caseload lists that identify those patients scheduled to be seen by a particular health care provider on a particular day;
means for generating schedules that group a plurality of audio annotations into audio annotation lists, wherein each audio annotation list groups the audio annotations by timeframe; and
means for securely accessing the audio data for the patient through a non-content-based index keyed to the electronic medical records system.

28. A system according to claim 26, wherein the computer-readable storage medium is securely connected to a local area network.

29. The system according to claim 1, wherein the scheduler is further configured to forward the audio annotations to a second healthcare provider.

30. The system according to claim 1, further comprising a cryptographic key to encrypt and decrypt the non-audio patient medical information identifiable by patient for exchange outside the electronic medical records system.
